(19) United States
(12) Patent Application Publication
(10) Pub. No.: US 2009/0019224 A1
(43) Pub. Date: Jan. 15, 2009

(54) Data Storage and Transfer Device and Method

(76) Inventor: Alan L. Pocrass, Simi Valley, CA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/815,355

(22) PCT Filed: Feb. 2, 2006
(86) PCT No.: PCT/US2006/003726

§ 371 Date: May 20, 2008

Related U.S. Application Data
(60) Provisional application No. 60/650,738, filed on Feb. 2, 2005.

(51) Int. Cl. G06F 12/02

(52) U.S. Cl. 711/115; 711/E12.008

(57) ABSTRACT

A data storage and transfer device includes the combination of a flash memory chip for storing data, a memory card connector, a male connector and a female connector configured to mate with the male connector. Data can be transferred to or from a memory card inserted in the memory card connector (1) from or to the flash memory chip, (2) via the male connector and/or (3) via the female connector Data can be transferred to or from the flash memory chip (1) from or to the memory card inserted into the memory card connector, (2) via the male connector and/or (3) via the female connector.

### BACKGROUND OF THE INVENTION

1. Field of the Invention

The present invention relates to a data storage and transfer device and method, and, more particularly, to a flash memory drive with integrated male and female connectors and at least one integrated memory card connector. A memory card can be inserted into each memory card connector and data can be copied to or from the memory card from or to the flash memory or one of the integrated male and female connectors. Each integrated memory card connector can be configured to mate with one memory card or a number of different styles of memory cards.

2. Description of Related Art

Flash memory drives are typically non-mechanical devices that can currently hold from about 8 megabytes (MB) to 4 gigabytes (GB) of data. A flash memory drive, such as a compact flash drive, connects to a computer via a Universal Serial Bus (USB) connector and can transfer data at rates of more than 1 MB per second. Current flash memory drives have male USB connectors that plug into female USB ports on a desktop computer, a laptop computer or a palm device. Ali advantage of a flash memory device is that it is small, portable, tough and has a large memory capacity. A typical flash memory drive is about the size and weight of a disposable lighter or a pack of gum. It can also be worn around a user's neck, attached to a key chain or easily fit into a handbag.

Currently, flash memory drives do not include any means for transferring information directly to another portable memory device without the use of an intelligent, programmed control device, such as, without limitation, a computer or a palm device. This limits the file sharing capabilities of such drives. Furthermore, the use of such drives limits the number of available USB ports on a computer that may be needed for printers, digital cameras, scanners and the like.

Moreover, current flash memory drives do not support the use of memory cards which can be used for storing and transferring data. Current memory cards have a small form factor and provide a flexible storage device for cameras, PDAs, laptops and all sorts of imaging and computing devices. Currently, memory cards come in a variety of types such as, without limitation:
CompactFlash (CF) Type I/II cards were developed by SanDisk in 1994. CF cards are based on PCMCIA (Personal Computer Memory Card International Association) specifications and can store up to 1 GB of data. CF cards are approximately 1.7″×1.4″ and come in two thicknesses—Type I CF cards are 3.3 mm thick, Type II CF cards are 5.5 mm;
IBM Microdrives are the size of a Type II CF card. IBM Microdrives hit the market in 1999 and can store up to 6 GB of data. IBM Microdrives use hard disk drive technology to store data;
Memory Stick and Memory Stick Pro were developed by Sony. Original memory sticks are about the size of an AA battery (rolled out flat) and can store up to 512 MB of data. Newer Memory Stick Pro can store up to 2 GB of data;
MultiMedia Cards (MMC) was jointly developed by SanDisk and Siemens. MMC cards are the size of a stamp and weigh about 2 grams. MMC cards can store up to 256 MB of data;
Secure Digital (SD) cards are designed to have low power requirements and high data transfer rates. SD cards are a bit smaller than MMC cards (still about the size of a stamp) and can store up to 2 GB of data. SD cards also support encryption of content so that manufacturers can sell and distribute copyrighted information with them;
Smart Media (SM) cards are larger than MMC and SC cards and store up to 128 MB of data (most often used on digital cameras and PDAs);
Ultra small memory card formats, such as, SanDisk's TransFlash (T-Flash) and Samsung's; and
MMC-micro cards, for cell phones and other small devices.

Accordingly, a need exists for a flash memory drive that can transfer data to another flash memory drive without the use of a computer. A further need exists for a flash memory drive that can mate with male USB connectors of other devices to enable data to be transferred to or from the flash memory drive without the use of another device. A further need exists for a flash memory drive with one or more integrated memory card connectors to provide the capability to insert a memory card into each memory card connector and transfer data to or from the memory card.

### SUMMARY OF THE INVENTION

The invention is a data storage and transfer device comprising a flash memory chip for storing data; a memory card connector; a male connector; a female connector configured to mate with the male connector; means for controlling a transfer of data to or from at least one of: a memory card inserted in the memory card connector (1) from or to the flash memory chip, (2) via the male connector and/or (3) via the female connector; and the flash memory chip (1) from or to the memory card inserted into the memory card connector, (2) via the male connector and/or (3) via the female connector.

At least one of said male and female connectors can be mated with a corresponding mating connector of another device when data is being transferred thereby to or from the flash memory card or the flash memory chip.

The other device can be another, like data storage and transfer device; a flash memory drive; a desktop or laptop computer; a palm device; a printer; a digital camera; or a scanner.

The device can further include at least one of: a battery coupled to provide power to the flash memory chip, the memory card connector and the means for controlling the transfer of data; means for facilitating electrical connection of at least one of said male and female connectors to a corresponding mating connector of another device; means for initiating the transfer of data; means for selecting the flash memory chip or the flash memory card to transfer data to or from; or means for indicating that the transfer of data is in progress.

The device can further include: means for retrieving digital audio data from the flash memory chip or the memory card; means for decoding the retrieved digital audio data; means for converting the decoded digital audio data to an analog signal; and an output connector for outputting the analog signal.

A plurality of buttons can be provided for enabling user control of (1) the movement of data from or to the flash memory chip or a memory card inserted in the memory card connector and/or (2) the playback of audio data stored in the flash memory chip or a memory card inserted in the memory card connector.

A display screen viewable via the enclosure can be provided to provide a visual indication of information related to data stored in the flash memory chip or a memory card inserted in the memory card connector.

The invention is also a method of transferring data within a data storage and transfer device. The method includes (a) providing a data storage and transfer device having the combination of a flash memory chip for storing data, a memory card connector, a male connector and a female connector configured to mate with the male connector; (b) inserting a memory card into the memory card connector; and (c) causing data to pass to or from the memory card from or to at least one of (1) the flash memory chip or (2) via one of the connectors when said connector is connected to a mating connector of another device.

The device can further include means for setting the memory drive to pass data to or from at least one of the memory card or flash memory chip via the one connector when it is connected to the mating connector of the other device and/or means for initiating the transfer of data from at least one of the memory card or flash memory chip via the one connector when it is connected to the mating connector of the other device.

Lastly, the invention is a data storage and transfer device comprising: an enclosure; a male USB connector at least partially disposed within the enclosure; a female USB connector at least partially disposed within the enclosure; a flash memory chip disposed in the enclosure; a memory card connector at least partially disposed within the enclosure; and means disposed in the enclosure for enabling data to pass to or from at least one of the flash memory chip or a memory card inserted in the memory card connector. Data passed to or from the flash memory chip is passed from or to one of (1) the memory card, (2) via the male USB connector when it is coupled to a mating connector of another device, or (3) via the female USB connector when it is coupled to a mating connector of another device. Data passed to or from the memory card is passed from or to one of (1) the flash memory chip, (2) via the male USB connector when it is coupled to a mating connector of another device, or (3) via the female USB connector when it is coupled to a mating connector of another device.

The other device can be another, like data storage and transfer device; a flash memory drive; a desktop or laptop computer; a palm device; a printer; a digital camera; or a scanner.

The memory can also include at least one of: a battery coupled to provide power to the flash memory chip and the means for enabling data to pass; means for facilitating electrical connection of at least one of said USB connectors to the mating connector of another device; means for initiating the transfer of data; means for selecting the flash memory chip or the flash memory card to transfer data to or from; and means for indicating that the transfer of data is in progress.

A switch can be provided for causing data to be transferred to or from the flash memory chip or the flash memory card as a function of the setting of the switch.

The memory card can be one of a compact flash; a microdrive; a MultiMedia card (MMC); a Secure Digital (SD) card; a Smart Media card; an ultra-small memory card; and an MMC-micro card.

### BRIEF DESCRIPTION OF THE DRAWINGS

FIG. 1 is an exploded perspective view of a data storage and transfer device in accordance with a first embodiment of the present invention;

FIG. 2 is an assembled perspective view of the device of FIG. 1;

FIG. 3 is a perspective view of the device of FIG. 1 interacting with a flash memory drive;

FIG. 4 is a perspective view of the device of FIG. 1 interacting with a USB cable having a male connector;

FIG. 5a is an exploded perspective view of a data storage and transfer device in accordance with a second embodiment of the present invention;

FIG. 5b is an assembled perspective view of the device of FIG. 5a;

FIG. 6 is a perspective view of a data storage and transfer device in accordance with a third embodiment of the present invention;

FIG. 7 is a flow-diagram of a method of transferring information from a device in accordance with the present invention to another device; and

FIG. 8 is a flow-diagram of a method of transferring data between a memory card inserted into a memory card connector of a device in accordance with the present invention and a flash memory chip of the device, or vice versa.

### DETAILED DESCRIPTION OF THE INVENTION

The present invention will be described with reference to the accompanying figures where like reference numbers correspond to like elements.

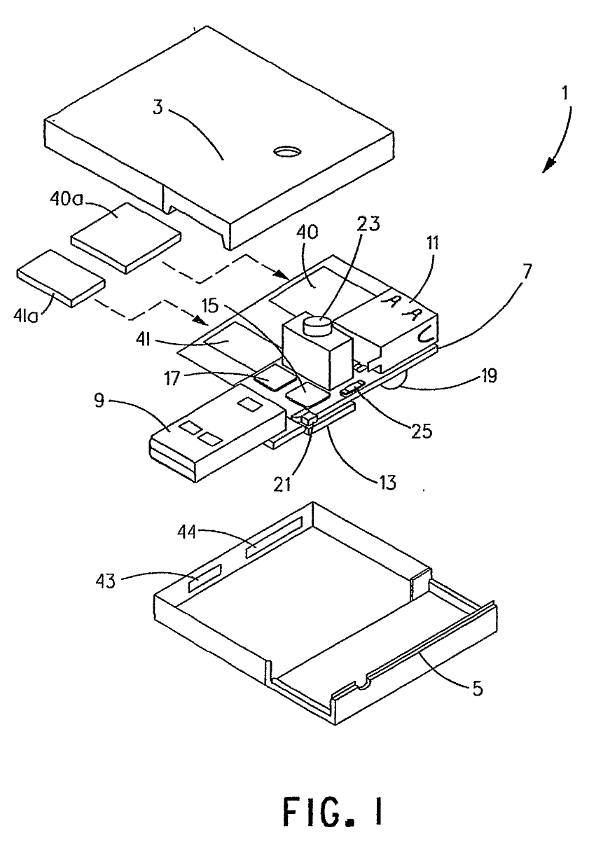

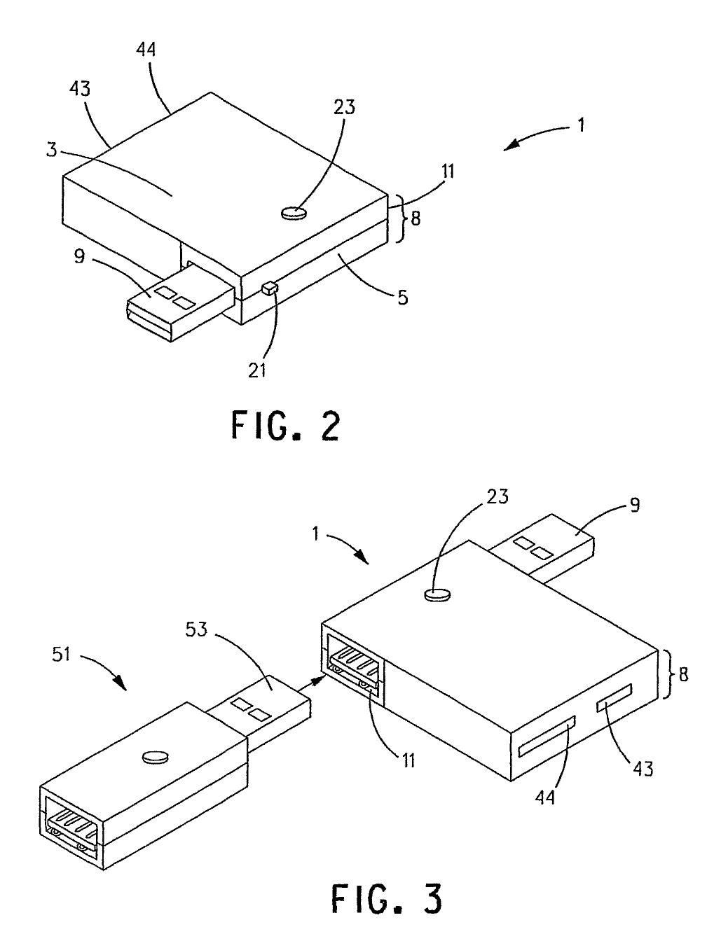

With reference to FIGS. 1 and 2, a data storage and transfer device 1 includes a top cover 3, a bottom cover 5 and a printed circuit board 7.

Top cover 3 and bottom cover 5 can mate around printed circuit board 7 and any components mounted thereon to form a protective housing 8. These covers can be made of a variety of materials, but are desirably made from, without limitation, plastic or metal.

Device 1 further includes a male USB connector 9 and a female USB connector 11. Desirably, connectors 9 and 11 are mini or mini-B type USB connectors. However, this is not to be construed as limiting the invention since it is envisioned that one or both of connectors 9 and 11 can be a USB-A type connector.

Male USB connector 9 and female USB connector 11 are mounted on printed circuit board 7 by soldering, surface mount technology, press fitting or other means of mounting components on printed circuit boards known in the art. Male USB connector 9 is configured to mate with female USB connector 11 or with a female USB connector of another intelligent programmed control device such as, without limitation, a desktop or laptop computer, a palm device, and the like, either directly or via an interface cable. Female USB connector 11 is configured to mate with male USB connector 9 or with a male USB connector of another device, such as, without limitation, a flash memory drive, an interface cable, or another device 1 in accordance with the present invention.

Device 1 further includes one or more memory card connector(s) 40 and/or 41 configured to receive one or more memory cards 40a and/or 41a, respectively. Each memory card connector 40, 41 can be configured to receive a single type memory card or can be configured to receive a plurality of different types of memory cards. Protective housing 8 includes one or more slots 44 and/or 43 that facilitate insertion and removal of memory card(s) 40a and/or 41a in a corresponding memory card connector(s) 40 and/or 41, respectively. Each memory card connector 40 and 41 is mounted on the printed circuit board 7 by soldering, surface mount technology, press fitting or other means of mounting components on printed circuit boards known in the art. For purposes of describing the present invention, two memory card connectors are shown. However, this is not to be construed as limiting the invention since it is envisioned that device 1 can include any number of memory card connector(s), including only one (1) or more than two (>2).

The purpose of each memory card connector 40, 41 of device 1 is to receive a corresponding memory card for the purpose of copying data to or from said memory card under the control of a download/copy logic chip 15. The configuration or layout of device 1 shown in the figures is not to be construed as limiting the invention since it is envisioned that device 1 can have any suitable and/or desirable configuration or layout.

In addition to printed circuit board 7 supporting male USB connector 9, female USB connector 11, one or more memory card connector(s) 40, 41 and download/copy logic chip 15, one or more flash memory chips 13, a hub logic chip 17 and a battery 19 can be mounted on printed circuit board 7 in a manner known in the art. Hereafter, it will be assumed that only one flash memory chip 13 is present. However, this is not to be construed as limiting the invention.

Each memory card connector 40, 41 is configured to receive at least one type of memory card. Examples of types of memory cards that memory card connector(s) 40, 41 of device 1 can be configured to receive include: a compact flash (CF) card, an IBM micro drive card, a Memory Stick Card, a Memory Stick Pro Card, a multimedia (MMC) card, a secured digital (SD) card, a smart media (SM) card, an ultra-small memory card, an MMC-micro card, and the like. However, this is not to be construed as limiting the invention since it is envisioned that device 1 can also or alternatively include any other suitable and/or desirable memory card connector configured to receive one or more other types or styles of memory cards. Accordingly, the foregoing list of memory cards is not to be construed as limiting the invention.

Flash memory chip 13 is configured to store data, e.g., anywhere from 8 megabytes to 1 gigabyte of data. However, this is not to be construed as limiting the invention since it is envisioned that flash memory chip 13 can have any suitable and/or desirable data storage capacity. Download/copy logic chip 15 facilitates the transfer of data to or from flash memory chip 13 and/or a memory card 40a or 41a inserted into a memory card connector 40a or 41a, respectively. Hub logic chip 17 facilitates connection of one or both of male USB connector 9 and female USB connector 11 to a universal serial bus having connected thereto one or more other devices, such as, without limitation, a flash memory drive, another device 1 in accordance with the present invention, a desktop or laptop computer, a palm device, a printer, a digital camera, a scanner, and the like.

Battery 19 provides power to flash memory chip 13, download/copy logic chip 15, hub logic chip 17, and any other component of device 1 requiring electrical power for its operation when device 1 is not attached to the USB port of an externally powered device, such as a computer, palm device, etc. Battery 19 enables the combination of flash memory chip 13, download/copy logic chip 15, hub logic chip 17 and any other component of device 1 requiring electrical power for its operation to: (1) transfer data from flash memory chip 13 to another device, such as, the flash memory chip of another flash memory drive, or vice versa, attached to male USB connector 9 or female USB connector 11 without the use of externally provided power; (2) transfer data from a memory card 40a or 41a inserted into the corresponding memory card connector 40 or 41, respectively, to flash memory chip 13, or vice versa, without the use of externally provided power; and/or (3) transfer data from a memory card 40a or 41a inserted into the corresponding memory card connector 40 or 41, respectively, to another device, such as, the flash memory chip of another flash memory drive, or vice versa, attached to male USB connector 9 or female USB connector 11 without the use of externally provided power.

A logic chip (not shown) can be provided for enabling the charging of battery 19 when male USB connector 9 or female USB connector 11 of flash memory drive 1 is connected to an externally powered device. While battery 19 is used in the present embodiment, it is envisioned that other power supplies, such as one or more solar cells, can be utilized to power chips 13, 15, and 17 and/or charge battery 19. While flash memory chip 13, download/copy logic chip 15, hub logic chip 17, and the logic chip for enabling the battery to charge are described above as separate chips, it is envisioned that that the function(s) of each of these chips can be incorporated into more or less, e.g., one or two chips. Accordingly, the number of chips described herein is not to be construed as limiting the invention.

With reference to FIG. 3 and with continuing reference to FIGS. 1 and 2, a flash memory drive 51, either a prior flash memory drive or a flash memory drive with integrated male and female connectors of the type disclosed in U.S. patent application Ser. No. 10/028,382, filed Jan. 3, 2005, (hereinafter “the '382 application”) which is incorporated herein by reference, and device 1 can be joined together by inserting the male USB connector 53 of flash memory drive 51 into the female USB connector 11 of device 1 for the purpose of transferring or copying data from the flash memory chip of flash memory drive 51 to at least one of the flash memory chip 13 of device 1 or a flash card 40a or 41a inserted into connector 40 or 41, respectively, of device 1, or vice versa.

Each device 1 can include a master/slave switch 21 coupled to download/copy logic chip 15 for setting device 1 as either a master or a slave. In operation, when flash memory drive 51 and device 1 are joined together with switch 21 set to the master portion, data transfers from device 1 to the flash memory chip of flash memory drive 51 under the control of download/copy logic chip 15. Alternatively, when flash memory drive 51 and device 1 are joined together with switch 21 set to the slave position, data transfers from the flash memory chip of flash memory drive 51 to device 1 under the control of download/copy logic chip 15.

Switch 21 can be a multi-position switch that not only sets device 1 as a master or slave, but also causes download/copy logic chip 15 to transfer data to or from flash memory chip 13, a memory card 40a or 40b inserted into a memory card connector 40 or 41, or both, either in parallel or serially, i.e., where the memory of flash memory chip 13 and the memory of the memory card are contiguous memory. For example, a first setting of switch 21 can cause download/copy logic chip 15 to transfer data from the flash memory chip of flash memory drive 51 to flash memory chip 13 of device 1, or vice versa. Another setting of switch 21 can cause download/copy logic chip 15 to transfer data from the flash memory chip of flash memory drive 51 to a memory card inserted into a memory card connector of device 1, or vice versa. Lastly, another setting of switch 21 can cause download/copy logic chip 15 to transfer data from the flash memory chip of flash memory drive 51 to flash memory chip 13 and a memory card inserted into a memory card connector of device 1, either in parallel or serially, i.e., flash memory chip 13 first followed by the memory card, or vice versa.

When two devices 1 in accordance with the present invention are joined together via the male USB connector 9 of one device 1 and the female USB connector 11 of the other device 1, the device 1 having its switch 21 set to the master position transfers data to the device 1 having its switch 21 set to the slave position in the manner discussed above. To avoid potential conflicts, if both switches 21 are set to the same position, i.e., the master position or the slave position, no transfer data transfer occurs. Thus, as can be seen, a device 1 in accordance with the present invention can be used with other devices 1 in accordance with the present invention, with prior art flash memory drives, or with flash memory drives with integrated male and female connectors as disclosed in the '382 application.

Desirably, when male USB connector 9 of device 1 is plugged into a female USB connector of an intelligent device, such as, a computer, a palm device, or other like intelligent device that is configured or programmed to control the transfer of data, and device 1 is set as a slave by master/slave switch 21, the transfer of data to or from device 1 in the manner described above can be controlled via the intelligent device in a manner known in the art. Thus, desirably, it is only when master/slave switch 21 sets device 1 as the master that download/copy logic chip 15 is operative for controlling the transfer of data to or from flash memory chip 13 of device 1 or a memory card inserted into a corresponding memory card connector of device 1. In contrast, when master/slave switch 21 sets device 1 as a slave, data can be transferred to or from flash memory chip 13 and/or a memory card inserted into a corresponding memory card connector under the control of another intelligent device coupled to device 1 via connector 9 or 11.

A push button switch 23 can be provided on printed circuit board 7 and accessible via top cover 3 to allow for manual activation of the transfer of data. For example, in response to activation of push button switch 23 of a device 1 set as a master by its master/slave switch 21, download/copy logic chip 15 transfers data from device 1 to another device coupled to device 1 via connector 9 or 11. However, the use of push button switch 23 is not to be construed as limiting the invention since it is envisioned that other control means can be utilized to cause the transfer of data to or from device 1. For example, device 1 can be responsive to the setting of master/slave switch 21 for transferring data to or from device 1.

Each device 1 can also include an optional lamp 25 that illuminates when data is being transferred to or from the device 1. Lamp 25 may be selected from any light emitting device, e.g., a light emitting diode, suitable for such application. Lamp 25 may be a mutli-colored lamp whereupon a first color is illuminated when data is being transferred from device 1 and a second color is illuminated when data is being transferred into device 1. Alternatively, a single lamp having multiple colors can be replaced with multiple lamps to perform the same function.

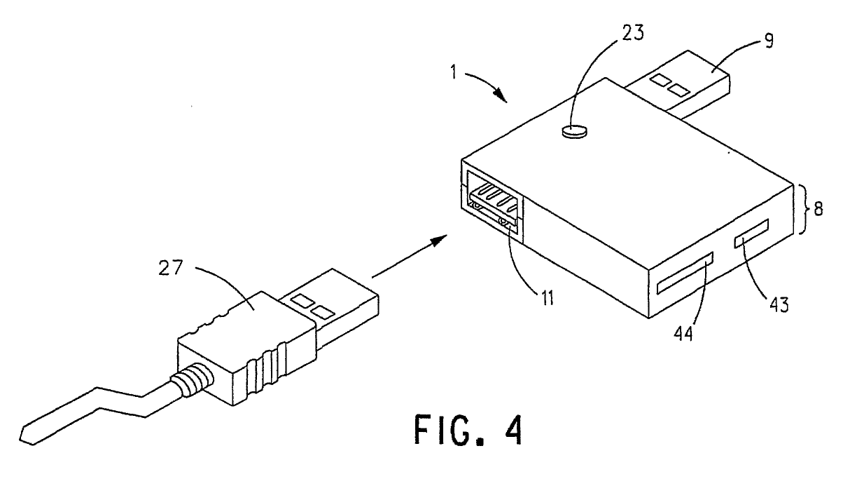

With reference to FIG. 4 and with continuing reference to FIGS. 1-3, device 1 may also be used to maximize the available USB ports on a computer or palm device. Specifically, male USB connector 9 of device 1 may be inserted into a USB port of a computer (not shown). Thereafter, female USB connector 11 can accept a male USB connector 27 of a USB cable coupled at its other end to a peripheral device such as, without limitation, a camera, a printer, a scanner or another flash memory drive thereby enabling said peripheral device to utilize the same USB port on the computer as device 1.

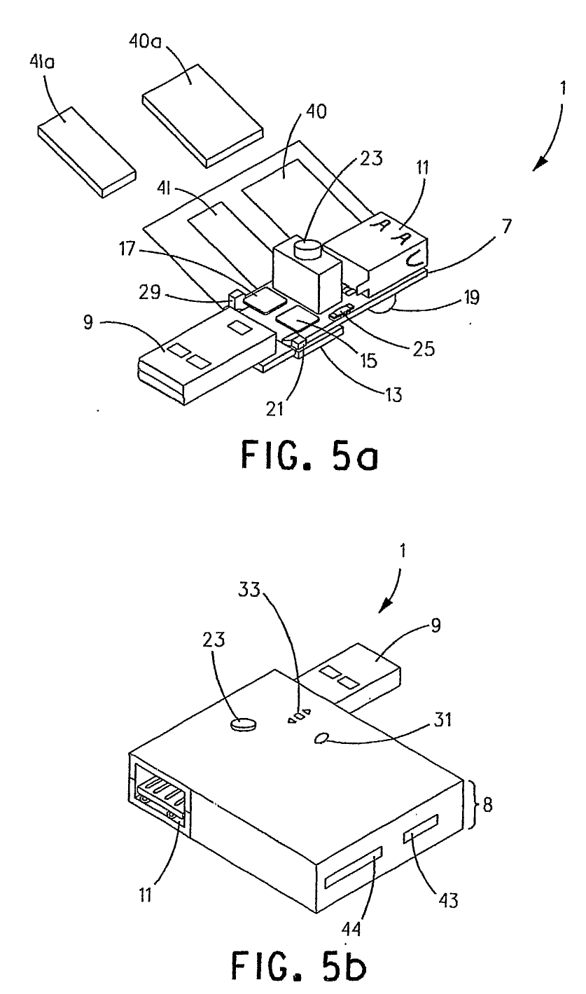

With reference to FIGS. 5a and 5b, a second embodiment of device 1 includes a digital audio chip 29 and an output connector 31, such as a headphone jack. Digital audio chip 29 includes a digital signal processor (DSP), an amplifier and a digital-to-analog converter (DAC). The DSP can retrieve a digital audio data file from flash memory chip 13 or a flash memory card 40a or 41a inserted into memory card connector 40 or 41, respectively, and can decode said retrieved digital audio data file utilizing a decompression algorithm, such as an mp3 or a wma decompression algorithm, that undoes the compression of the digital audio data stored in a corresponding compressed format. Then, the DAC converts the decompressed audio data file back into analog audio data. Finally, the amplifier boosts the strength of the analog signal and sends it to output connector 31.

Buttons 33 can be provided on top cover 3 for controlling digital audio chip 29. Buttons 33 can perform such functions such as, without limitation, volume control, playing, stopping, pausing, skipping, rewinding, fast forwarding, deleting and the like. Buttons 33 can also enable selection of where the digital audio data file is stored and/or retrieved, namely, flash memory chip 13 or a flash memory card 40a or 41a inserted into memory card connector 40 or 41, respectively. While push button switch 23 is shown, the function provided by push button switch 23 can be incorporated into one or more buttons 33, whereupon push button switch 23 can be omitted from the embodiment shown in FIGS. 5a and 5b.

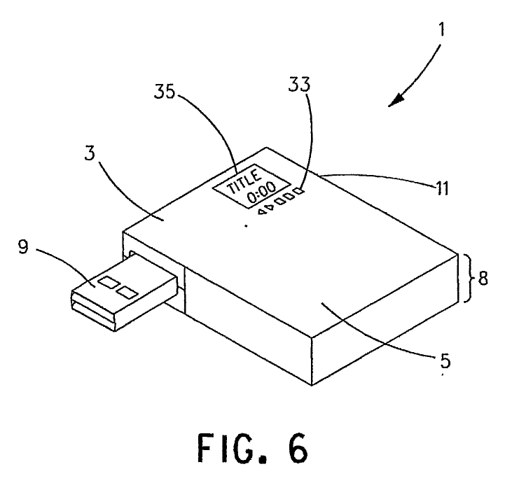

With reference to FIG. 6, a third embodiment device 1 includes a display screen 35 viewable via top cover 3. Display screen 35 can be connected to suitable circuitry (not shown) mounted on printed circuit board 7 for providing a visual indication of the name of a data file, the title of a digital audio data file, the time remaining in a song and other useful and/or desirable information. This embodiment can replace push button 23 and/or master/slave switch 21 with buttons 33. Device 1 can be programmed whereupon the combination of display screen 35 and buttons 33 can cooperate to provide to a user of device 1 a menu that includes user selectable options for controlling device 1 to perform any suitable and/or desirable function, such as, without limitation, selecting a digital audio data file for playing, selecting a data file for deletion, selecting a desired equalization to be applied to digital audio data files being played, selecting a data file to be moved, and the like.

Device 1 can also or alternatively be programmed so that download/copy logic chip 15 is responsive to the actuation of one or more buttons 33 for setting the device to be a master or a slave. A visual indication of “Master” or “Slave” can be provided on display screen 35. A signal can also be sent to download/copy logic chip 15 to initiate the transfer of data to or from flash memory chip 13 or a flash memory card 40a or 41a inserted in connector 40 or 41, respectively, when another one of the buttons 33 is pressed. A visual indication such as “Transfer in Progress” may be provided on display screen 35, thereby obviating the need for LED 25. Display screen 35 can be a liquid crystal display (LCD), a plasma screen or the like.

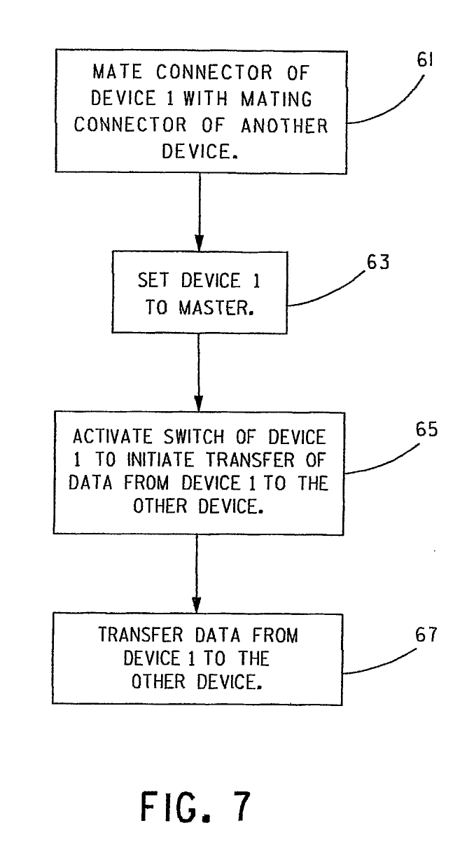

With reference to FIG. 7, the present invention is also a method for transferring, i.e., copying or moving, data to or from flash memory chip 13 or a memory card 40a or 41a inserted into memory card connector 40 or 41, respectively, of device 1. The method begins at step 61 by mating the male connector (or female connector) of device 1 with the female connector (or male connector) of another device. Next, at step 63, device 1 is set to the master mode. Then, at step 65, a switch is activated to initiate the transfer of data from the flash memory chip 13 or a memory card 40a or 41a of device 1. At step 67, the data is transferred from device 1 to the other device.

The other device can be another device 1 set to a slave, a flash memory drive with integrated male and female connectors of the type disclosed in the '382 application, a prior art flash memory drive, and the like. Also or alternatively, when device 1 is set to the slave mode and is coupled via its male connector with the female connector of a computer, a palm device, or other like intelligent, programmed control device, the transfer of data to or from the flash memory chip 13 or a memory card 40a or 41a can be controlled by the computer, palm device, or other like intelligent device.

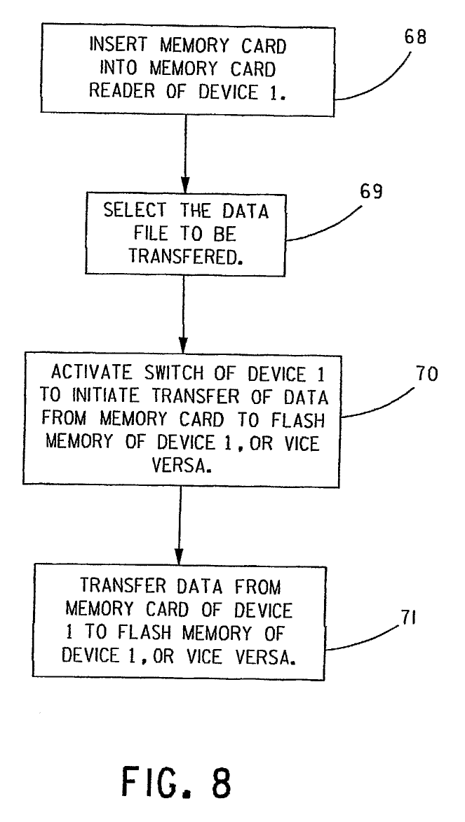

With reference to FIG. 8, the present invention is also a method for transferring data to or from flash memory chip 13 from or to a memory card 40a or 41a inserted into memory card connector 40 or 41. The method begins at step 68 by inserting a flash memory card 40a or 41a into a memory card connector 40 or 41 of device 1. Next, at step 69, the data file to be copied is selected in either the memory card 40 or 41 or the flash memory chip 13. The selection of the data file to be copied can be made in any suitable and/or desirable manner. For example, where device 1 includes display screen 35 and buttons 33, said buttons and display screen can be utilized to select the data file to be copied. Then, at step 70, a switch is activated to initiate the transfer of data from the memory card 40 or 41 to the flash memory chip 13, or vice versa. The direction of data transfer from the memory card 40 or 41 to the flash memory chip 13, or vice versa, can be selected in any suitable and/or desirable manner. For example, where device 1 includes display 35 and buttons 33, said display and buttons can be utilized to select the direction of data transfer. At step 71, the data transfers from the memory card 40 or 41 to the flash memory chip 13, or vice versa.

The invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A data storage and transfer device comprising:
a flash memory chip for storing data;
a memory card connector;
a male connector;
a female connector configured to mate with the male connector; and
means for controlling a transfer of data to or from at least one of:
a memory card inserted in the memory card connector (1) from or to the flash memory chip, (2) via the male connector and/or (3) via the female connector; and
the flash memory chip (1) from or to the memory card inserted into the memory card connector, (2) via the male connector and/or (3) via the female connector.

2. The device of claim 1, wherein at least one of said male and female connectors is mated with a corresponding mating connector of another device when data is being transferred thereby to or from the flash memory card or the flash memory chip.

3. The device of claim 2, wherein the other device is one of:
another, like data storage and transfer device;
a flash memory drive;
a desktop or laptop computer;
a palm device;
a printer;
a digital camera; and
a scanner.

4. The device of claim 1, further comprising at least one of:
a battery coupled to provide power to the flash memory chip, the memory card connector and the means for controlling the transfer of data;
means for facilitating electrical connection of at least one of said male and female connectors to a corresponding mating connector of another device;
means for initiating the transfer of data;
means for selecting the flash memory chip or the flash memory card to transfer data to or from; and
means for indicating that the transfer of data is in progress.

5. The device of claim 1, further comprising:
means for retrieving digital audio data from the flash memory chip or the memory card;
means for decoding the retrieved digital audio data;
means for converting the decoded digital audio data to an analog signal; and
an output connector for outputting the analog signal.

6. The device of claim 1, further comprising a plurality of buttons for enabling user control of (1) the movement of data from or to the flash memory chip or a memory card inserted in the memory card connector and/or (2) the playback of audio data stored in the flash memory chip or a memory card inserted in the memory card connector.

7. The device of claim 6, further comprising a display screen viewable via the enclosure for providing a visual indication of information related to data stored in the flash memory chip or a memory card inserted in the memory card connector.

8. The device of claim 1, wherein the memory card is one of:
a compact flash;
a microdrive;
a MultiMedia card (MMC);
a Secure Digital (SD) card;
a Smart Media card;
an ultra-small memory card; and
an MMC-micro card.

9. The device of claim 1, wherein the male and female connectors are USB connectors.

10. A method of transferring data within a data storage and transfer device comprising:
(a) providing a data storage and transfer device having the combination of a flash memory chip for storing data, a memory card connector, a male connector and a female connector configured to mate with the male connector;
(b) inserting a memory card into the memory card connector; and
(c) causing data to pass to or from the memory card from or to at least one of (1) the flash memory chip or (2) via one of the connectors when said connector is connected to a mating connector of another device.

11. The method of claim 10, wherein the device further includes means for setting the memory drive to pass data to or from at least one of the memory card or flash memory chip via the one connector when it is connected to the mating connector of the other device.

12. The method of claim 10, wherein the device further includes means for initiating the transfer of data from at least one of the memory card or flash memory chip via the one connector when it is connected to the mating connector of the other device.

13. A data storage and transfer device comprising:
an enclosure;
a male USB connector at least partially disposed within the enclosure;
a female USB connector at least partially disposed within the enclosure;
a flash memory chip disposed in the enclosure;
a memory card connector at least partially disposed within the enclosure; and
means disposed in the enclosure for enabling data to pass to or from at least one of the flash memory chip or a memory card inserted in the memory card connector, wherein:
data passed to or from the flash memory chip is passed from or to one of (1) the memory card, (2) via the male USB connector when it is coupled to a mating connector of another device, or (3) via the female USB connector when it is coupled to a mating connector of another device; and
data passed to or from the memory card is passed from or to one of (1) the flash memory chip, (2) via the male USB connector when it is coupled to a mating connector of another device, or (3) via the female USB connector when it is coupled to a mating connector of another device.

14. The device of claim 13, wherein the other device is one of:
another, like data storage and transfer device;
a flash memory drive;
a desktop or laptop computer;
a palm device;
a printer;
a digital camera; and
a scanner.

15. The device of claim 13, further comprising at least one of:
a battery coupled to provide power to the flash memory chip and the means for enabling data to pass;
means for facilitating electrical connection of at least one of said USB connectors to the mating connector of another device;
means for initiating the transfer of data;
means for selecting the flash memory chip or the flash memory card to transfer data to or from; and
means for indicating that the transfer of data is in progress.

16. The device of claim 13, further comprising a switch for causing data to be transferred to or from the flash memory chip or the flash memory card as a function of the setting of the switch.

17. The device of claim 13, wherein the memory card is one of:
a compact flash;
a microdrive;
a MultiMedia card (MMC);
a Secure Digital (SD) card;
a Smart Media card;
an ultra-small memory card; and
an MMC-micro card.
